(19) United States
(12) Patent Application Publication
(10) Pub. No.: US 2023/0164156 A1
(43) Pub. Date: May 25, 2023

(54) DETECTION OF ABNORMAL EVENTS

(71) Applicant: IronNet Cybersecurity, Inc., McLean, VA (US)

(72) Inventors: Robert L. Grossman, River Forest, IL (US); Jason P. Heath, Sugarloaf Key, FL (US)

(21) Appl. No.: 17/531,696

(22) Filed: Nov. 19, 2021

(51) Int. Cl. F03D 7/04

(52) U.S. Cl. CPC H04L 63/1425; F03D 7/048; H04L 63/1466; H04L 63/1416

(57) ABSTRACT

The present disclosure describes methods, apparatuses, and systems to protect wind turbines, wind farms, and power infrastructure. For instance, wind turbines produce several streams of data varying over time, including sensor readings from components in wind turbines, network traffic from SCADA systems, data from wind farm internal networks, data from the internet, etc. According to the techniques described herein, wind farms may be protected by identifying patterns that may not be apparent from individual time series or network data. Embodiments of the present disclosure include integration and fusion of information from various time series data sources and network data sources for detecting patterns in data (e.g., patterns in data that may indicate an abnormal event, such as wind farm component failure, a control system cyber-attack, etc.). For instance, in some cases, such patterns may be used to detect an abnormal event of interest (e.g., such as an attack).

### BACKGROUND OF THE INVENTION

### 1. Field of the Invention

The present invention relates generally to detection of abnormal events, and more specifically to detection of abnormal events detected as a function of a time-varying data stream. Even more specifically, the present invention related generally to detection of abnormal wind farm events detected as a function of a time-varying data stream in a wind farm.

### 2. Discussion of the Related Art

Various systems and processes are known in the art for detection of abnormal wind farm events.

For instance, supervisory control and data acquisition (SCADA) is a control system architecture comprising computers, networked data communications, and graphical user interfaces (GUI) for high-level process supervisory management. In some cases, SCADA may include peripheral devices such as programmable logic controllers (PLC) and discrete proportional-integral-derivative (PID) controllers to interface with process plant or machinery. For example, SCADA is used for management and operations of project-driven-processes in construction.

A SCADA computer system handles operator interfaces which enable monitoring and issuing of process commands such as controller set point changes. Subordinated operations, e.g., real time control logic or controller calculations are performed by networked modules connected to the field sensors and actuators.

In some cases, wind farms may be controlled by systems such as SCADA control systems. However, in some aspects, wind farms may be vulnerable to component failures, network reconnaissance, network exploitation, cyberattacks, etc. There is a need in the art for more efficient wind farm mitigation techniques that can identify and process large amounts of data to detect abnormal events related to failures and attacks (e.g., in order to protect individual wind turbines, wind farms, and associated power grids when such abnormal events are detected).

### SUMMARY

An apparatus, system, and method for detection of abnormal events are described. One or more aspects of the apparatus, system, and method include a first time-varying data stream input, wherein the first time-varying data stream input receives a first time-varying data stream of a SCADA system; a network interface, wherein the network interface receives network traffic; a processor coupled to the first time-varying data stream input and to the network interface, wherein the processor comprises a code segment configured to identify an event of interest from the first time-varying data stream and the network traffic, and generate a mitigation signal in response to the detecting of the event of interest; and a mitigation output coupled to the processor, wherein the mitigation output provides the mitigation signal.

A method, apparatus, non-transitory computer readable medium, and system for detection of abnormal events are described. One or more aspects of the method, apparatus, non-transitory computer readable medium, and system include providing a first time-varying data stream input, wherein the first time-varying data stream input receives a first time-varying data stream of a SCADA system; providing a network interface, wherein the network interface receives network traffic; identifying a scenario in the first time-varying data stream and the network traffic; detecting an event of interest as a function of the scenario; generating a mitigation signal in response to the detecting of the event of interest; and providing a mitigation, wherein a mitigation output provides the mitigation signal.

An apparatus, system, and method for detection of abnormal events are described. One or more aspects of the apparatus, system, and method include a first time-varying data stream input, wherein the first time-varying data stream input receives a first time-varying data stream of a SCADA system; a second time-varying data stream input, wherein the second time-varying data stream input receives a second time-varying data stream of the SCADA system; a network interface, wherein the network interface receives network traffic; a processor coupled to the first time-varying data stream input, and to the network interface, wherein the processor comprises a code segment configured to identify a scenario in a combination of two or more of the first time-varying data stream, the second time-varying data stream, the network traffic, and data generated by simulation, detect an event of interest as a function of the scenario, select a model as a function of the event of interest, and generate a mitigation signal in response to the model; and a mitigation output coupled to the processor, wherein the mitigation output provides the mitigation signal.

### BRIEF DESCRIPTION OF THE DRAWINGS

FIG. 1 shows an example of a wind turbine according to aspects of the present disclosure.

FIG. 2 shows an example of a wind farm according to aspects of the present disclosure.

FIGS. 3 through 5 show examples of an abnormal event detection system according to aspects of the present disclosure.

FIG. 6 shows an example of a time series analysis diagram according to aspects of the present disclosure.

FIGS. 7 through 8 show examples of an abnormal event detection system according to aspects of the present disclosure.

FIGS. 9 through 12 show examples of a process for wind farms according to aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present description describes an implementation of various aspects in the context of a wind farm. However, it will be appreciated that the teachings of the present description have application to other operating environments, particularly where one or more time-varying data streams are utilized along with one or more sources of network traffic.

Wind farms are controlled by systems (e.g., supervisory control and data acquisition (SCADA) systems) that may be vulnerable to failures or attacks. For instance, wind farms interface to power grids, and complex interactions between the wind farms and the power grids can damage the wind farm system, the power grid system, or both. Wind farms also include wind turbines (e.g., which are complex mechanical systems themselves) that may experience component failure. Further, wind farms and corresponding control centers may be connected to the internet according to various configurations. Thus, wind farms may be vulnerable to network reconnaissance, network exploitation, cyberattacks, etc.

In some cases, machine learning systems are used to protect wind farms from such failures and attacks. However, the large amount of data (e.g., large time series data produced by a wind farm) may be complex and detecting unusual events in such data may be challenging due to the volume, velocity, and complexity of the data.

For instance, wind farms (e.g., wind turbines) may produce and manage large and complex data such as large numbers of time-varying data streams including sensor measurements and other SCADA readings. Sensor measurements and SCADA readings from the wind turbine may include turbine temperature measurements, revolutions per minute of shafts, blade position information, measurements of local weather (e.g., wind speed, wind direction, temperature, humidity, etc.), data pertaining to the state of the local power grid (e.g., including electrical phases), data pertaining to the state of the energy market (e.g., including the current price of electricity), etc. In some cases, various other time varying series of data may be produced and tracked in wind farm systems.

The complexity of such data may result in challenges in identifying both previously observed events of interest as well as new events of interest that have not yet been observed. Accordingly, conventional mitigation techniques (to protect individual wind turbines, the wind farm, and the attached power grid) may be deficient. Therefore, there is a need in the art for more efficient wind farm mitigation techniques that are capable of identifying and processing such events of interest related to failures and attacks in order to protect individual wind turbines, wind farms, and associated power grids.

The present disclosure describes methods, apparatuses, and systems to protect wind turbines, wind farms, and power infrastructure. For instance, wind turbines produce several streams of data varying over time, including sensor readings from components in wind turbines, network traffic from SCADA systems, data from wind farm internal networks, data from the internet, etc. For example, the Internet may be used to obtain weather data including wind speed, temperature, etc. Additionally, wind turbines may generate electrical data including current and phase from the wind farm, as well as data from an external power grid that is supplied by the farm.

According to the techniques described herein, wind farms may be protected by identifying patterns that may not be apparent from individual time series or network data. Embodiments of the present disclosure include integration and fusion of information from various time series data sources and network data sources for detecting patterns in data (e.g., patterns in data that may indicate an abnormal event, such as wind farm component failure, a control system cyber-attack, etc.). For instance, in some cases, such patterns may be used to detect an abnormal event of interest (e.g., such as cyberattack) in real time resulting in timely mitigation or emergency actions to protect a wind turbine or wind farm.

According to some aspects of the techniques described herein, patterns over two or more time series may be identified. For example, identified patterns may indicate a compromise, attack, or an upcoming failure that might not be apparent to the system by only observing a single source of time series data.

For instance, efficient wind farm function may be disrupted due to a rare combination of events that the system has not previously experienced or been exposed to. Thus, conventional machine learning approaches may not be sufficient, as some machine learning techniques may rely on previous scenarios (e.g., being trained on each possible scenario) to detect similar scenarios in the future.

One or more embodiments of the disclosure include combination of patterns and scenarios from multiple wind farms to increase detection of events and scenarios of interest. For example, rare scenarios from a wind farm may be combined with rare scenarios from another wind farm to produce (e.g., simulate) more extremely rare scenarios. As a result, techniques described herein may more efficiently detect abnormal events of interest even if some of the more extreme rare case scenarios occur for the first time (e.g., as the described techniques may be implemented to simulate such rare cases or may leverage information from other wind farm systems that may have experienced and collected data for such rare cases).

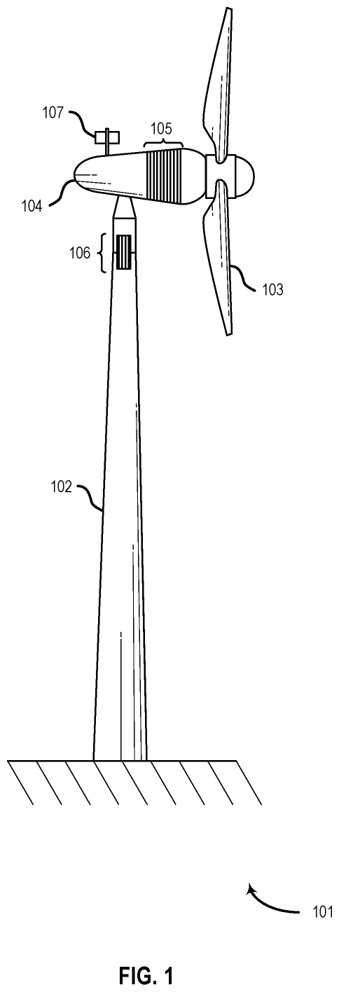

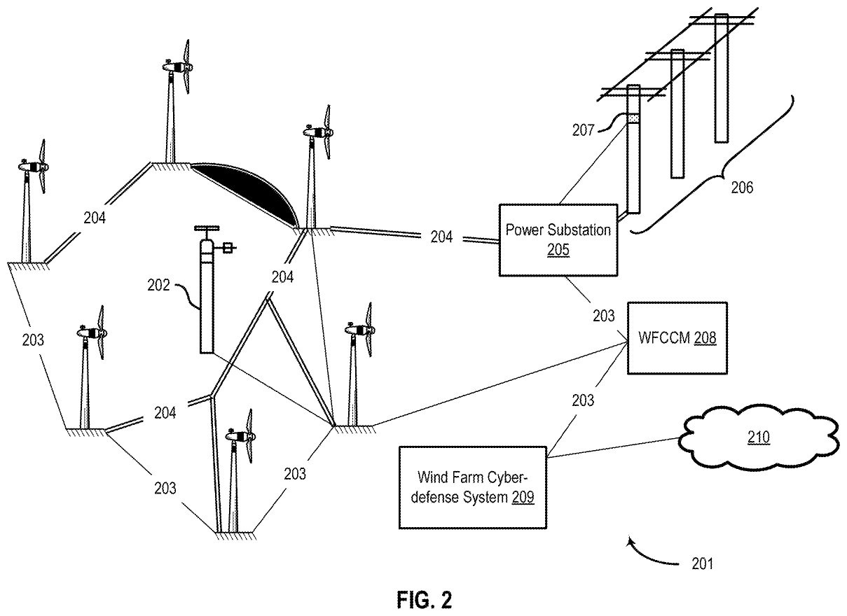

FIG. 1 shows an example of a wind turbine 101 according to aspects of the present disclosure. Wind turbine 101 is an example of, or includes aspects of, the corresponding elements described with reference to FIGS. 2-5, and 7. In one aspect, wind turbine 101 includes tower 102, rotor blade 103, body 104, (e.g., a Nacelle 104) which holds mechanical components 105 (e.g., including a gearbox, electrical generator, brakes, sensors, etc.), a yaw system 106, and anemometer 107. The wind anemometer 107 and a wind vane measure the wind speed and wind direction such that multiple components, including the yaw system 106 (e.g., a yaw motor and yaw drive), can position the rotor blade 103 to face the wind direction and increase efficiency of the wind turbine.

In some embodiments multiple modalities of time series data for wind turbines 101 are collected and communicated via a network interface to a SCADA network. In some cases, a mechanical state of the wind turbine provided by sensors may include speed and pitch of turbine rotor blades 103 is collected and communicated to the SCADA network. In some examples, the current, voltage, and frequency (or phase) of the power produced by wind turbines 101 in a wind farm 201 are collected and communicated to the SCADA network. The local weather around each wind turbine 101 may be collected, using multiple sensors such as wind speed using anemometers 107, temperature using thermometers, atmospheric pressure using barometers, etc., and communicated to the SCADA network. In some cases, the sensor data collected is a continuous time series prior to any sampling and digitization. The status of the hardware and software components managing the wind turbine 101 is collected by capturing log events, performance monitoring of the software systems, etc.

FIG. 2 shows an example of a wind farm 201 according to aspects of the present disclosure. In one aspect, wind farm 201 may include various configurations of wind turbines 101. Generally, wind farms 201 may include one or more wind turbines 101 (e.g., as described with reference to FIG. 1). The mechanical and electrical components in the wind farm 201 may include sensors, controllers, and other components connected to the wind farm system 203. Generally the wind farm system 203 may include a SCADA network, a computer network, etc. Wind farm system 203 may connect multiple digital components and digital devices in the wind farm 201. The wind farm 201 includes a weather station 202 that captures weather data for the wind farm.

The power generated by individual generators in wind turbines 101 is carried on a power network 204 to a power substation 205. The power substation 205 transforms the power and provides power to the power grid 206. The power, phase, and other characteristics of the external power grid 206 are monitored by sensors 207 (e.g., power meters and multi-meters) which transmit the captured information to the wind farm control center module (WFCCM) 208. Information from the wind farm control center module 208 is provided to the wind farm cyber-defense system 209 which is connected to the internet 210.

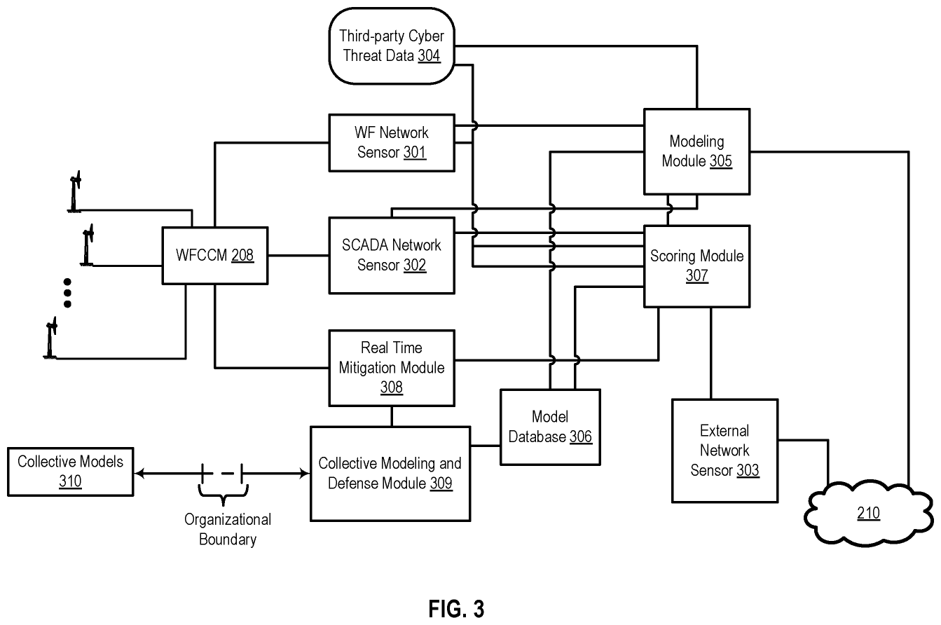

FIG. 3 shows an example of an abnormal event detection system according to aspects of the present disclosure. An embodiment of the disclosure includes data collection by a network sensor from an operational network of a wind farm 201. In some examples, a wind farm network sensor 301 can collect data from the internal operational network of a wind farm 201. For example, the collected data is used for building machine learning and artificial intelligence (AI) models to detect and mitigate cyberattacks, system failures, component/sensor failures, etc. The SCADA network sensor 302 and the external network sensor 303 collect data from the corresponding networks. Additionally, third-party data such as cyber threat data 304 may be used to build machine learning and AI models. In some cases, machine learning and AI models (e.g., modeling module 305) can be built with the data, can be stored in model database 306, and can be deployed using scoring module 307. In some examples, the models are used for real time detection of malicious activity, which can be mitigated using emergency action and real time mitigation module 308 by taking the appropriate emergency actions and mitigations. For example, emergency actions and mitigations may include shutting down specific wind turbines 101, isolating certain network segments, taking devices containing software that is compromised off-line, etc. For instance, emergency action and real time mitigation module 308 may generate mitigation signals and cause wind farm control center module 208 to perform certain emergency actions and real time mitigations described herein.

Embodiments of the present disclosure include multiple models that enable detection of different types of malicious activities. For example, models from the model database 306 may be used in the scoring module 307 to detect malicious activities that may not be detected with a single model. For example, models that detect potentially malicious SCADA activity, network activity on the networked wind farm, etc., can be run using scoring module 307. Additionally, integrated models that detect potentially malicious activity from features using SCADA and wind farm activity can be run at the same time using scoring module 307.

Detection models are developed that do not use any proprietary information on the wind farm using modeling module 305. The detection models can be used to monitor threat using scoring module 307 and shared with other wind farms through the collective modeling and defense module 309. Alternatively, collective models 310 (e.g., models built from other wind farms) may be used to increase detection of malicious activity using scoring module 307. As a result, emergency actions may be taken to mitigate risks using emergency action and real time mitigation module 308.

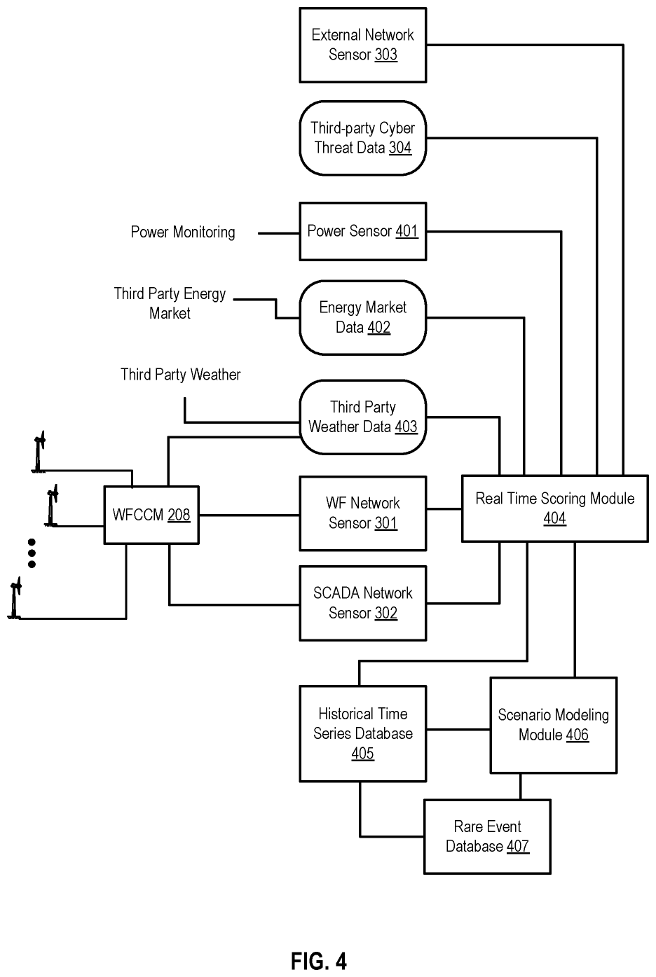

FIG. 4 shows an example of an abnormal event detection system according to aspects of the present disclosure. In addition to data collection for individual wind turbines 101 (e.g., as described in more detail herein, for example, with reference to FIG. 1) time series data may be collected for wind farms 201. For example, status of the hardware and software components managing the wind farm 201 is collected by capturing log events and performance monitoring of the hardware and software systems. Similarly, network traffic entering the local area network associated with the wind farm is collected using log files, message streams, and other digital streams associated with monitoring of hardware and software systems. Further, power characterization of the power grid (e.g., using voltage, current, frequency, phase, etc.) that is connected to the associated wind farm 201 is captured by power meters and multi-meters (e.g., sensors 207). In some cases, energy market data 402 (e.g., market price and demand for electricity) is captured along with weather data 403 (e.g., regional weather data, national weather data, etc.) using third-party sources. In some examples, third-party cybersecurity threat intelligence (e.g., third-party cyber threat data 304) may be collected.

The present disclosure describes systems and methods that detect the system compromise (e.g., system attack, etc.) by a third-party. For example, the third-party may be able to control one or more wind turbines 101, cause failures of component systems in a wind turbine 101, perform a cyberattack on the wind turbine 101, etc.

The time series data produced by a wind turbine 101 in historical time series database 405 is recorded to deal with the volume, velocity, and complexity of the time series data produced. Next, scenario modeling module 406 is used with one or more techniques from time series modeling and machine learning to identify scenarios that summarize time series and combination of time series.

In some examples, a scenario may refer to summarization of a portion of a time series, or a portion of 2 or more time series using a single label, a single number, or a single vector. If n scenarios are used, the labels 1, 2, 3, . . . , n are used without a loss of generality. Scenarios may be built with different time windows and using time series (e.g., 1 time series, 2 time series, or more time series) in different ways. For example, a time series may be divided into fixed length windows and the windows may be mapped to a scenario vector or a label.

Next, the scenarios are stored in a scenario and rare event database 407. In some cases, the scenarios are low dimension summaries of the time series and may change over time. In some cases, the rate of change of scenarios is very low since scenarios change each time a window or a collection of windows changes. For example, a time series may record sensor readings at a rate of 60 measurements per second, while there may only be 100 scenarios, for example, corresponding to the time series and these may change only every few minutes or even every hour or longer.

Referring to FIG. 3, in some examples, unusual scenarios are collected for the time series and shared through collective modeling and defense module 309 with one or more collective defense operation centers 310. In some examples, the operation centers may provide collective defense for multiple wind farms with multiple wind farm operators, owners, and companies.

Referring back to FIG. 4, real time scoring module 404 monitors time series in real time and uses the scenario modeling module 406 to identify scenarios for each time series or a combination of time series. In some cases, one or more models from the model database 306 are used to process the time series corresponding to each scenario. The models may integrate wind farm (WF) network 301 data, SCADA network sensor 302 data, power sensor 401 data, energy market data 402, and third party weather data 403. The models may be used to identify anomalies and other events of interest using scenario modeling module 406. For example, anomalies or other events of interest, and the outputs of the machine learning models are used with real time scoring module 404 and with emergency action and real time mitigation module 308 to take necessary actions and mitigations. In some cases, the events of interest and the models enable detection of possible compromise, cyberattacks, or equipment failures in wind turbines 101 and a wind farm control system (e.g., in wind farm control center module 208).

The present disclosure describes systems and methods for extraction of scenarios from multiple time series. In some examples, scenarios are extracted from two or three (e.g., or more) of the time series data including the wind farm network 301 data, SCADA network sensor 302 data, power sensor 401 data, energy market data 402, and/or weather data 403. Alternatively, scenarios may be extracted from other time series that the wind farm control center module 208 may produce to identify anomalies and events of interest that are not visible in a single time series.

Scenarios from one or more time series identified by the scenario modeling module 406 are stored in the scenario and rare event database 407. In some cases, events may include scenarios or combination of scenarios along with information related to event occurrence, status of multiple SCADA networks, and other systems at the time of occurrence. Therefore, the information may be used to compute actions, mitigations, and warnings that can be provided to the emergency action and real time mitigation module 308 to reduce the impact on wind farm 201.

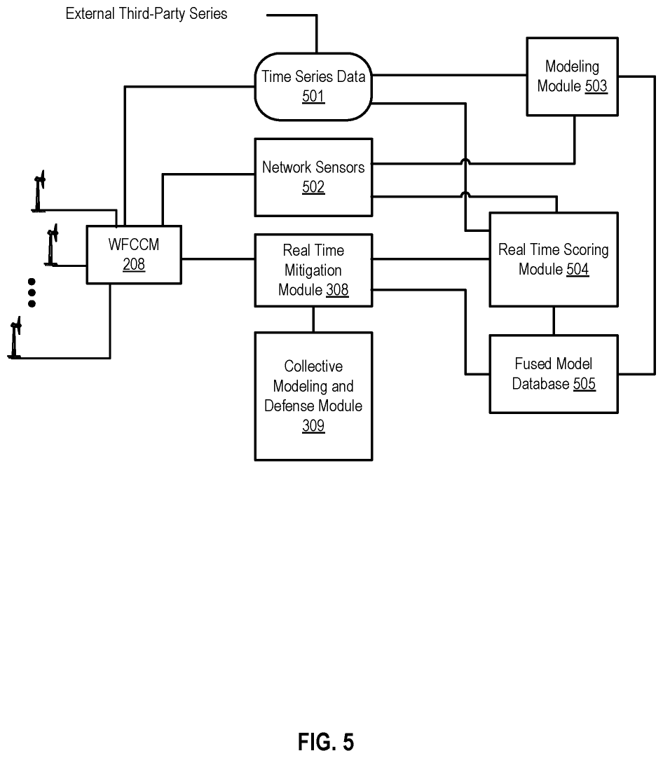

FIG. 5 shows an example of an abnormal event detection system according to aspects of the present disclosure. An embodiment of the disclosure includes network traffic data for abnormal event detection modeling. In some cases, the data may be obtained from one or more networks sensors 502 for modeling module 503. For example, the one or more network sensors 502 may include SCADA network sensor 302, wind farm network sensor 301, external network sensor 303, etc.). Additionally, one or more time series data (e.g., such as power sensor 401 data, energy market data 402, weather data 403, etc.) are applied to the modeling module 503. The modeling module 503 can build machine learning and AI models that use data from network sensors 502 (e.g., wind farm network data from wind farm network sensor 301, SCADA network data from SCADA network sensor 302) and time series data 501 (e.g., which may include external third party time series data, such as weather data, energy market data, cyber security data, etc.). In some cases, the modeling module 503 may combine, integrate, and fuse the information to create fused models.

Additionally, modeling module 503 may access multiple models in the model database 306 and multiple time series in the historical time series database 405. Next, modeling module 503 may use different machine learning and AI techniques to build fused models that are built using network data and time series data. In some cases, the fused models may include features, scenarios, and information from one or more time series. Additionally, the fused models may include features, scenarios, events, and other information from multiple networks. The fused models are stored in the fused model database 505 and are used for real time scoring of time series and network traffic using real time scoring module 504. Real time scoring module 504 may perform real time scoring (e.g., and real time abnormal event detection) using fused models (e.g., models form fused model database 505). For instance, emergency actions and other mitigations can be taken using emergency action and real time mitigation module 308 based on results of the real time scoring module 504.

Additionally, models, scores, and events of interest can be shared with other wind farms using the collective modeling and defense module 309 without revealing private information about the wind farm 201 (e.g., abnormal event detection system information can be shared without exposing sensitive or private information of the wind farm 201 or the wind farm control center module 208).

Particularly, models from the fused model database 505 can be used in a scoring engine (e.g., in real time scoring module 504) based on specific scenarios identified using real time scoring module 404 and scenario modeling module 406. Thus, specific emergency actions and mitigations can be taken based on specific scenario identified in real time using real time scoring module 404 and scenario modeling module 406.

An embodiment of the disclosure includes scenario vectors and feature vectors for a window. In some cases, scenario vectors can be computed for an individual time series or for two or more series. Similarly, feature vectors may be computed from the network data for the window. Additionally, time series feature vectors and network data feature vectors can be concatenated to train a machine learning or deep learning model which can be used for scoring the real time data using real time scoring module 504.

An embodiment of the disclosure includes a deep learning model for time series data. In some cases, the deep learning model may be built for the network data. Additionally, cross-domain deep learning can be used to increase performance of the network data model using time series model, and vice versa. In some examples, the network data and time series models may run together.

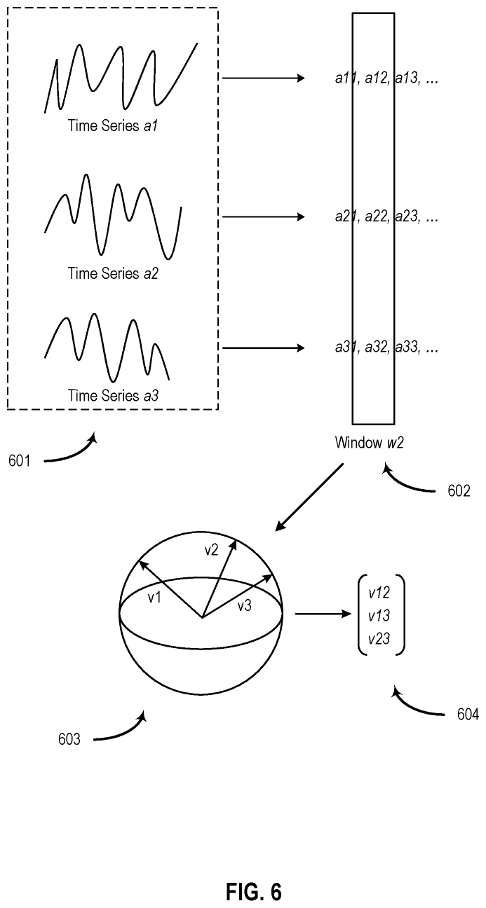

FIG. 6 shows an example of a time series analysis diagram according to aspects of the present disclosure. In some cases, scenarios may be computed from multiple time series. An embodiment of the disclosure includes feature extraction from individual time series. In some cases, features may be normalized followed by concatenation with features for multiple time series. For example, the normalized features range between 0 and 1. In some examples, scenarios living in a low dimensional feature space, e.g., dimension k, can be computed by projecting the concatenated time series to k-random unit vectors through the origin using a random projection method.

The k dimensional scenario vectors can be computed from n-dimension vectors using k dimensional principal components. Alternatively, the k dimensional scenario vectors may be computed using deep learning to construct an autoencoder.

An embodiment of the disclosure includes relationships between different features vectors to define the scenario vector.

An embodiment of the disclosure includes a plurality of time series with features computed in a moving window 602. For example, time series data 601 (e.g., a plurality of time series a1, a2, a3, . . . etc.) may be used with features a11, a12, a13, . . . , a21, a22, a23, . . . , computed in a moving window 602. In case of n features for the time series, points on the unit sphere in dimension n−1 may be considered normalized features.

For instance, for each time series i and for each window j, a feature vector aij is computed in dimension n. For each vector a12, a22, and a32 associated with window w2 for example, a randomized projection 603 is computed in dimension k to get vectors v1, v2 and v3. Features of the vectors vi for window w2 may be computed to create the scenario vector 604, such as the angle in k-dimensions between v1 and v2, between v2 and v3, and between v1 and v3. In other words, angles between various points on the unit sphere can be used to compute a scenario vector 604. For example, in a p time series, q=p(p−1)/2 angles are computed between p points on the unit sphere to form a scenario angle vector of length q. Distances between scenario vectors can be used to identify normal scenarios and unusual scenarios. Finally, scenarios and related purposes may be clustered.

The k-dimensional individual scenario vectors for time series and q angles between the vectors can be used by the system to track scenarios over time. In some examples, the angles between the vectors may define the q-dimensional summary scenario vector that summarizes the n different time series in a window 602.

Alternatively, k dimensional time series specific scenario vectors can be computed from n-dimension vectors by using k dimensional principal components. In some examples, the k dimensional time series specific scenario vectors may be computed using deep learning to construct an autoencoder that produces k dimensional scenario vectors. Therefore, using one of these methods, or other methods for reducing the n-dimensional feature vector to k-dimensions, the k-dimensional individual scenario vectors for each time series and the q angles between them that define the q-dimensional summary scenario vector that summarize all the n different time series in a window can then be used by the system to track scenarios over time.

One or more embodiments of the present disclosure include binning of scenario vectors to create a finite number of scenarios. For example, the first component of the vector is binned into m1 bins, the second into m2 bins, the third into m3 bins, to produce m (=m1* m2* m3* . . . ) bins. Similarly, m discrete scenarios are defined and real time scoring module 404 is used to compute a scenario at an interaction time. For example, the interaction refers to interaction of a wind farm with external events from power sensor 401, energy market data 402, weather data 403, etc. The binning method can be used to bin the k-dimensional vector of an individual or more than one time series. In some cases, features of the time series are concatenated before dimensional reduction to k-dimensions or the q-dimensional summary scenario from two or more time series.

The binning method may be considered a discrete event or discrete state that characterizes an individual time series or more than one time series in a certain window 602.

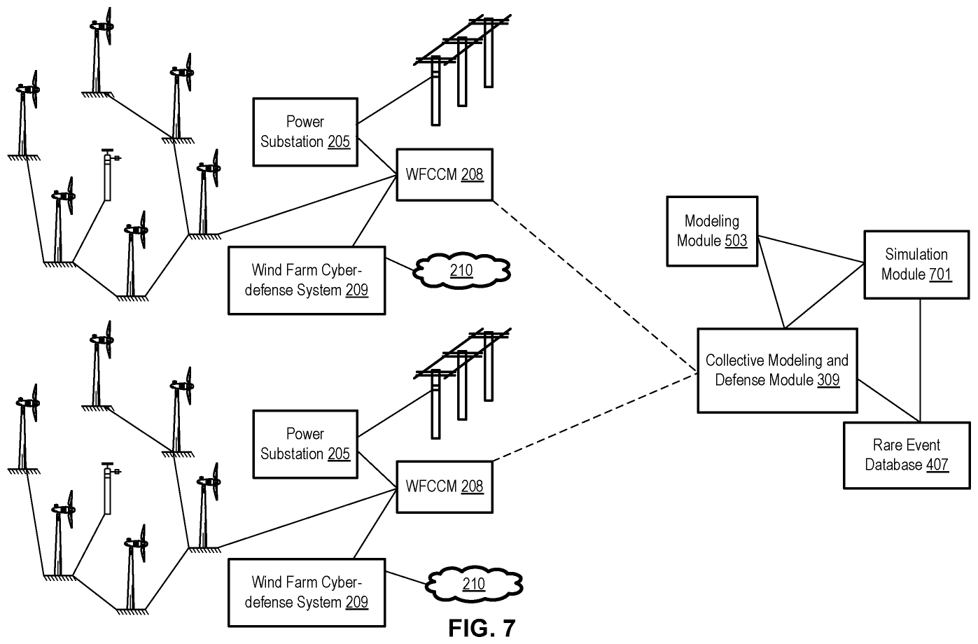

FIG. 7 shows an example of an abnormal event detection system according to aspects of the present disclosure. The present disclosure describes systems and methods for detecting and processing system failures, malicious network activity from multiple networks, etc. For example, cyberattacks against wind turbines and wind farms may include SCADA system attacks and/or the attacks to the internal operational network used by various sensors, devices, computers, and other networked components in a single wind turbine (e.g., as described in more detail herein, for example, with reference to FIG. 1) or in multiple turbines in a wind farm (e.g., as described in more detail herein, for example, with reference to FIG. 2).

One or more embodiments of the disclosure include scenarios or combinations of scenarios that can be considered events. For example, some events are common while some events are less common. In some cases, combinations of unusual events in various orders are simulated in simulation module 701 to determine rare combinations of events and scenarios that may be investigated further. In some examples, such scenarios may be stored in scenario and rare event database 407 and are used to determine additional combinations of events with new data that might result in dangerous situations. In case a combination of rare or unusual events are found to be of concern, mitigating and protective actions are developed and deployed to real time scoring module 504. Appropriate protective actions are developed and are sent to wind farm 201 (e.g., wind farm control center module 208) or a wind turbine 101 within the wind farm 201.

One or more embodiments of the present disclosure include a scenario and rare event database that may use a module for simulations. In some cases, scenarios and rare events (e.g., from the scenario and rare event database 407) may be used to create synthetic events using the simulation module 701. Thus, fusion models may be trained on synthetic data. In some cases, fusion models are used for real time scoring (e.g., via real time scoring module 504), as well as for collective defense (e.g., using collective modeling and defense module 309).

An embodiment of the disclosure includes computation and examination of scenarios and events. In some cases, the examination determines appropriate mitigations and emergency actions for use by multiple wind farms without revealing confidential information. For example, events and scenarios from a second wind farm can be used to create scenarios and events that would have not been observed from a first wind farm.

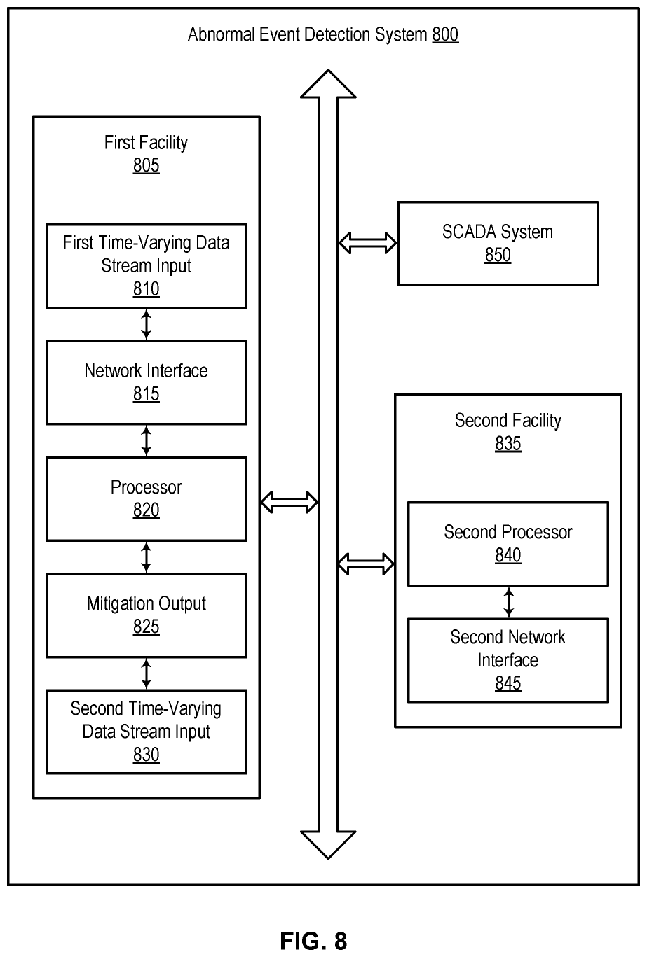

FIG. 8 shows an example of an abnormal event detection system 800 according to aspects of the present disclosure. In one aspect, abnormal event detection system 800 includes first facility 805, second facility 835, and SCADA system 850.

In some cases, labeled historical time series datasets are generated that can be used to develop machine learning models to predict and avoid future equipment failure and potential system attacks. In some examples, certain cyber events or certain combinations of system events may individually be safe. However, other combinations of events may be dangerous and can impact operations and cause failures of power systems.

For example, an event may result in loss of electricity for several thousand residents in a city. The loss of electricity may result due to an unlikely combination of events that may start with a lightning strike. The time of the lightning strike may coincide with separation of small-embedded generators from the network due to a standard protective mechanism. Additionally, if an offshore wind farm reduces the energy supply to the grid along with tripping of steam turbine of the power station which reduces energy supply to the grid resulting in power disruption. The protection mechanisms for the lightning strike may perform appropriately and the disruption of power may be caused by the unusual combination of events that occurred at approximately the same time. Such an unusual combination of events is very rare and standard machine learning and rule-based systems may be able to detect multiple types of rare events and take appropriate actions.

A processor 820 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 820 is configured to operate a memory array using a memory controller. In other cases, a memory controller is integrated into the processor 820. In some cases, the processor 820 is configured to execute computer-readable instructions stored in a memory to perform various functions. In some embodiments, a processor 820 includes special purpose components for modem processing, baseband processing, digital signal processing, or transmission processing.

In some examples, abnormal event detection system 800 may include, or be coupled to, a memory device. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor 820 to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In some examples, abnormal event detection system 800 may include, or be coupled to, one or more databases (e.g., as described in more detail herein). A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with database controller. In other cases, database controller may operate automatically without user interaction.

In some examples, abnormal event detection system 800 may include, or be coupled to, a cloud. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

In some examples, abnormal event detection system 800 may include a transceiver. A transceiver may communicate bi-directionally, via antennas, wired, or wireless links as described above. For example, the transceiver may represent a wireless transceiver and may communicate bi-directionally with another wireless transceiver. The transceiver may also include or be connected to a modem to modulate the packets and provide the modulated packets for transmission, and to demodulate received packets. In some examples, transceiver may be tuned to operate at specified frequencies. For example, a modem can configure the transceiver to operate at a specified frequency and power level based on the communication protocol used by the modem.

As described herein, abnormal event detection system 800 may implement neural networks, machine learning models, AI, etc. A neural network is a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network (ANN) is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A deep neural network may be composed of multiple layers of latent variables with connections between the layers but not between units within each layer. When initially trained on a set of examples without supervision, a deep neural network can learn to probabilistically reconstruct its inputs. The layers can act as feature detectors. After initial training, a deep neural network can be further trained with supervision to perform classification.

According to some aspects, abnormal event detection system 800 provides a first time-varying data stream input 810, where the first time-varying data stream input 810 receives a first time-varying data stream of a SCADA system 850. In some examples, abnormal event detection system 800 provides a network interface 815, where the network interface 815 receives network traffic. In some examples, abnormal event detection system 800 identifies a scenario in the first time-varying data stream and the network traffic. In some examples, abnormal event detection system 800 detects an event of interest as a function of the scenario. In some examples, abnormal event detection system 800 generates a mitigation signal in response to the detecting of the event of interest. In some examples, mitigation output 825 provides the mitigation signal.

In some examples, abnormal event detection system 800 provides a second time-varying data stream input 830, where the second time-varying data stream input 830 receives a second time-varying data stream of the SCADA system 850. In some aspects, the scenario is identified in the first time-varying data stream, the second time-varying data stream, and the network traffic, where the scenario is not apparent in the first time-varying data stream and the network traffic without the second time-varying data stream. In some aspects, the first time-varying data stream is provided by a wind farm. In some examples, abnormal event detection system 800 identifies at least one external event from a second wind farm. In some examples, abnormal event detection system 800 detects the event of interest as a function of the scenario and the at least one external event.

In some aspects, the data is synthetic data generated by a digital twin. In some aspects, the data is synthetic data generated by combining two or more time varying data streams. In some aspects, the first time-varying data stream input 810 is provided from a first facility 805. In some examples, abnormal event detection system 800 receives, at a second facility 835, the mitigation signal from the mitigation output 825. In some aspects, the first facility 805 is a first wind farm and the second facility 835 is a second wind farm.

In one aspect, first facility 805 includes first time-varying data stream input 810, network interface 815, processor 820, mitigation output 825, and second time-varying data stream input 830.

According to some aspects, first time-varying data stream input 810 receives a first time-varying data stream of a SCADA system 850. In some aspects, the SCADA system 850 is coupled to a wind farm.

According to some aspects, network interface 815 receives network traffic.

According to some aspects, processor 820 is coupled to the first time-varying data stream input 810 and to the network interface 815, wherein the processor 820 comprises a code segment configured to identify an event of interest from the first time-varying data stream and the network traffic, and generate a mitigation signal in response to the detecting of the event of interest. In some aspects, the event of interest is identified based on identifying a scenario in the first time-varying data stream and the network traffic, and detecting the event of interest as a function of the scenario.

In some aspects, the processor 820 includes the code segment configured to identify the scenario in the first time-varying data stream, the second time-varying data stream, and the network traffic, where the scenario is not apparent in the first time-varying data stream and the network traffic without the second time-varying data stream. In some aspects, the processor 820 is further coupled to an external data stream from a second wind farm and the code segment is further configured to identify at least one external event and detect the event of interest as a function of the scenario and the at least one external event. In some aspects, the code segment is further configured to identify the scenario where the data is synthetic data generated by a digital twin. In some aspects, the code segment is further configured to identify the scenario where the data is synthetic data generated by combining two or more time varying data streams.

In some examples, the code segment is configured to identify a scenario in a combination of two more of the first time-varying data stream, the second time-varying data stream, the network traffic, and data generated by simulation. The code segment may detect an event of interest as a function of the scenario, select a model as a function of the event of interest, and generate a mitigation signal in response to the model.

According to some aspects, mitigation output 825 is coupled to the processor 820, wherein the mitigation output 825 provides the mitigation signal.

According to some aspects, second time-varying data stream input 830 receives a second time-varying data stream of the supervisory control and data acquisition system.

In one aspect, second facility 835 includes second processor 840 and second network interface 845.

In some aspects, abnormal event detection system 800 is located at a first facility 805. In some examples, second processor 840 is located at a second facility 835, wherein the second facility 835 is a remote facility. In some aspects, the first facility 805 is a first wind farm and the second facility 835 is a second wind farm.

According to some aspects, second network interface 845 is at the second facility 835, wherein the second network interface 845 is coupled to the second processor 840, and is coupled to the network interface 815 via a computer network, wherein the mitigation output 825 is coupled to the network interface 815 and wherein the network interface 815 transmits the mitigation signal to the second network interface 845 via the computer network, and wherein the second processor 840 comprises a second code segment configured to receive the mitigation signal from the mitigation output 825 via the computer network.

SCADA is a means of remote access to multiple local control modules. In some cases, the modules may be from different manufacturers which enable access through standard automation protocols. For example, a large SCADA system 850 may be considered similar to a distributed control system in function that uses multiple means of interfacing with the plant, physical, or mechanical system. SCADA systems 850 can control large-scale processes that include multiple sites, and work over a range of distances (e.g., small and large distances). As a result, SCADA systems 850 are commonly used as industrial control systems.

### SCADA Control Operations:

A SCADA system performs a supervisory operation over multiple other proprietary devices. For example, SCADA may provide computerized control over functional levels in a manufacturing operation or physical or mechanical system. In some examples, a level may include field devices (e.g., flow and temperature sensors) and final control elements (e.g., control valves). A second level comprises industrialized input/output (I/O) modules and the associated distributed electronic processors. For example, the second level uses programmable logic controllers (PLCs) or remote terminal units (RTUs).

A third level contains supervisory computers which collate information from processor nodes on the system and provide operator control screens. The third level includes SCADA with readings and equipment status reports that are communicated to the third level SCADA as required. Next, the data is compiled and formatted such that a control room operator using a human machine interface (HMI) can make supervisory decisions to adjust or override normal RTU (or PLC) controls. In some examples, data may be provided to a history database to provide for trending, analytical auditing, etc. In some cases, SCADA systems 850 use a tag database which contains data elements called tags or points, which relate to specific instrumentation or actuators within the process system. In some examples, data may be accumulated for process control equipment tag references.

A fourth level may be a production control level which monitors production and targets and thus indirectly controls the process. A final level may include production scheduling.

### Examples of SCADA Use:

A SCADA system may help build large and small systems. In some examples, systems developed by SCADA may include a few thousand control loops depending on the application. For example, SCADA is used for industrial, infrastructural, and facility-based processes. Industrial processes include manufacturing, process control, power generation, fabrication, and refining, and may run in continuous, batch, repetitive, or discrete modes. Infrastructural processes may be public or private, and may include water treatment and distribution, wastewater collection and treatment, oil and gas pipelines, electric power transmission and distribution, wind farms, etc. Facility processes, include monitoring and controlling temperature, ventilation, air conditioning systems (HVAC), access, and energy consumption for buildings, airports, ships, space stations, etc. SCADA systems are also used to control physical or mechanical systems, such as wind turbines and wind farms. SCADA systems 850 are evaluated to identify risks and the corresponding solutions are implemented to mitigate security vulnerabilities.

### SCADA System Components:

A SCADA system includes supervisory computers, remote terminal units, programmable logic controllers, communication infrastructure, and a human-machine interface.

### SCADA Supervisory Computers:

Supervisory computers may be considered the core of the SCADA system. For example, the computers are used to gather data on the process and send control commands to field connected devices. Supervisory computers refer to the computer and software responsible for communicating with field connection controllers. In some examples, the field connection controllers may be RTUs, PLCs, etc. and include HMI software running on operator workstations. In some cases, a small SCADA system may include a supervisory computer that may be composed of a single personal computer (PC) such that the HMI is part of the computer. Alternatively, in large SCADA systems 850, the master station may include multiple HMIs hosted on client computers, multiple servers for data acquisition, distributed software applications, and disaster recovery sites. In some examples, the multiple servers may be configured using duplicate components (e.g., dual-redundant) or active spare parts (e.g., hot-standby formation) providing continuous control and monitoring in the event of a server malfunction or breakdown. As a result, the integrity of a SCADA system is increased.

### Remote Terminal Units:

Remote terminal units (RTUs) connect to sensors and actuators in a process and are networked to the supervisory computer system. In some cases, RTUs include embedded control capabilities and conform to PLC standards (e.g., IEC 61131-3) for programming and support automation using ladder logic, function block diagram, multiple other languages, etc. For example, RTUs may be used in remote locations without local infrastructure to enable monitoring of a small solar power system using radio, GSM, or satellite for communications. Additionally, RTUs are ruggedized to work in extreme temperatures, i.e., from −20° C. to +70° C. or −40° C. to +85° C. without external heating or cooling equipment.

### Programmable Logic Controllers:

Programmable logic controllers (PLCs) are connected to sensors and actuators in the process and are networked to the supervisory system. For example, PLCs may include a high-speed connection to the SCADA system in a factory automation setting. Similarly, PLCs may connect directly to SCADA over a wireless link, or use an RTU for the communications management in remote applications such as a large water treatment plant. In some examples, PLCs are designed for control at remote sites with a large number for input output (I/O) devices.

### Communication Infrastructure:

Communication infrastructure connects the supervisory computer system to the RTUs and PLCs and may use industry standard or manufacturer proprietary protocols. RTUs and PLCs operate autonomously on the near-real time control of the process using the last command provided by the supervisory system. For example, the plant process controls may not stop due to failure of the communications network. Additionally, the operator can continue with monitoring and control on resumption of communications. In some cases, critical systems may include dual redundant data highways cabled using diverse routes.

### Human Machine Interface:

The human-machine interface (HMI) is the operator window of the supervisory system. The HMI presents plant, physical or mechanical systems information to the operating personnel graphically in the form of mimic diagrams. In some examples, mimic diagrams are a schematic representation of the plant being controlled, alarm or event logging pages. The HMI is linked to the SCADA supervisory computer to provide live data to drive the mimic diagrams, alarm displays, and trending graphs. The HMI may be a graphical user interface for the operator that collects data from external devices, creates reports, performs alarming, sends notifications, etc., in multiple installations.

In some cases, mimic diagrams include line graphics and schematic symbols to represent process elements or may include digital images of the process equipment covered with animated symbols.

In some cases, the HMI enables supervisory operation of the plant which includes issuing commands by operators using mouse pointers, keyboards, and touch screens. For example, a symbol of a pump can show the operator that the pump is running, and a flow meter symbol can show the amount of fluid being pumped through the pipe. The operator can stop the pump using the mimic by a mouse click or screen touch. In some examples, the HMI shows real time decrease in flow rate of the fluid in the pipe.

The HMI package for a SCADA system includes a drawing program that the operators or system maintenance personnel use to change the way the points are represented in the interface. The representations can be simple such as an on-screen traffic light which represents the state of an actual traffic light in the field. Alternatively, representations may be complex such as a multi-projector display representing the position of the elevators in a skyscraper or the trains in a railway station.

In some examples, a history database is a software service in the HMI that accumulates time-stamped data, events, and alarms in a database which can be queried or used to populate graphic trends in the HMI. For example, the historian is a client that requests data from a data acquisition server.

### Alarm Handling:

Alarm handling is a part of SCADA implementations that monitors whether certain alarm conditions are satisfied and determines timing of an alarm event. In some cases, one or more actions are taken once an alarm event is detected. For example, an action may include activation of one or more alarm indicators, and generation of email or text messages to transfer information to management or remote SCADA operators. A SCADA operator may acknowledge the alarm event resulting in deactivation of some alarm indicators. In some examples, alarm conditions are cleared to deactivate the indicators.

Alarm conditions can be explicit or implicit. For example, an alarm point is a digital status point with two values (i.e., normal or alarm) that are calculated by a formula based on values in other analogue and digital points. Alternatively, a SCADA system may automatically determine if the value in an analogue point lies outside high- and low-limit values associated with the point.

In some examples, alarm indicators include a siren, a pop-up box on a screen, or a colored or flashing area on a screen. The role of the alarm indicator is to draw the attention of an operator to the affected part of the system for appropriate action.

### PLC/RTU Programming:

Smart RTUs or standard PLCs may autonomously execute simple logic processes without involving the supervisory computer. In some cases, the RTUs and PLCs use standardized control programming languages that include function block, ladder, structured text, sequence function charts, and instruction list. In some examples, the programming language may include minimal training requirements. As a result, SCADA system engineers may perform design and implementation of a program to be executed on an RTU or PLC.

A programmable automation controller (PAC) is a compact controller that combines the features and capabilities of a PC-based control system with a typical PLC. PACs are deployed in SCADA systems 850 to provide RTU and PLC functions. Distributed RTUs may use information processors or station computers to communicate with digital protective relays, PACs, and other devices for I/O, and communicate with a SCADA master in SCADA applications for an electrical substation.

### PLC Commercial Integration:

An embodiment of the disclosure includes integrated HMI/SCADA systems that use open and non-proprietary communications protocols. In some cases, specialized third-party HMI/SCADA packages include built-in compatibility with major PLCs which enables mechanical engineers, electrical engineers, and technicians to configure HMIs without using a custom-made program written by a software programmer. An RTU connects to a physical equipment. For example, an RTU converts electrical signals from the equipment to digital values and controls the equipment by converting and sending signals to equipment.

### Communication Infrastructure and Methods:

Conventional SCADA systems use combinations of radio and direct wired connections. In some examples, SONET/SDH may be used for large systems such as railways and power stations. Telemetry refers to the remote management or monitoring function of a SCADA system. In some cases, users may want SCADA data to travel over pre-established corporate networks or share the network with other applications.

SCADA protocols are compact by design. In some cases, protocols are designed to send information when the master station polls the RTU. For example, SCADA protocols include Modbus RTU, RP-570, Profibus, and Conitel. The communication protocols are standardized and contain extensions to operate over networking specifications such as TCP/IP. In some examples, network simulation can be used jointly with SCADA simulators to perform what-if analysis.

Security demands have led to an increase in use of satellite-based communication. Satellite-based communication includes self-contained infrastructure (i.e., without use of circuits from public telephone system), built-in encryption, and may be engineered to the availability and reliability needed by the SCADA system operator.

In some cases, standardized automation protocols are used for RTUs and other automatic controller devices to increase interoperability.

### SCADA Architecture Development:

Architecture of SCADA systems 850 includes four generations, i.e., monolithic, distributed, networked, and web based.

Common network services did not exist when a first-generation SCADA system was developed and hence the system computing was done by large minicomputers. As a result, first generation SCADA systems 850 are independent systems with no connectivity to other systems. A back-up mainframe system connected to RTU sites achieves first generation SCADA system redundancy. In some cases, the back-up mainframe system may be used in the event of failure of the primary mainframe system. For example, first generation SCADA systems 850 are developed as turnkey operations that run on minicomputers such as the PDP-11 series.

A second-generation SCADA system includes information and command processing that may be distributed across multiple stations connected through a LAN. In some cases, information is shared in near real time. Each station is responsible for a particular task resulting in cost reduction. Non-standardized network protocols are used since limited people (i.e., except the SCADA developers) know details of installation security.

A complex third generation SCADA system can be reduced to simple components and connected through communication protocols. The system may be spread across more than one LAN network called a process control network (PCN) and separated geographically for a networked design. Multiple distributed architecture SCADAs may be run in parallel with a supervisor and historian may be considered a network architecture. As a result, a cost-effective solution is provided for very large-scale systems.

Fourth generation SCADA systems 850 use the internet to implement web technologies while enabling users to view data, exchange information, and control processes from anywhere in the world through a web SOCKET connection. For example, a web SCADA system uses internet browsers (e.g., Google® Chrome and Mozilla® Firefox) as the graphical user interface (GUI) for the operators HMI. As a result, installation at the client side is simplified. Additionally, users are able to access the system from multiple platforms with web browsers such as servers, personal computers, laptops, tablets, mobile phones, etc.

SCADA systems 850 include capabilities to centralize facilities such as power, oil, gas pipelines, wind turbines and water farms, water distribution, and wastewater collection systems. In some cases, use of SCADA makes the systems open, robust, and easily operable and repairable. However, the move from proprietary technologies to standardized and open solutions with increased number of connections has made SCADA systems 850 vulnerable to network attacks. For example, United States computer emergency readiness team (US-CERT) issued a vulnerability advisory warning that unauthenticated users can download sensitive configuration information including password hashes from an inductive automation ignition system utilizing a standard attack type leveraging access to a web server (e.g., Tomcat Embedded web server). Similarly, an advisory is available regarding a buffer overflow vulnerability, for example in a Wonderware InBatchClient ActiveX control. In some examples, vendors make updates available prior to public vulnerability release. In some cases, mitigation recommendations are standard patching practices and require VPN access for secure connectivity. Consequently, the security of some SCADA-based systems is questionable as the systems are potentially vulnerable to cyber-attacks.

In some cases, security researchers are concerned about lack of user interest in security and authentication in design, deployment, and operation of existing SCADA networks. For example, users may believe that SCADA systems 850 include security through obscurity due to use of specialized protocols and proprietary interfaces. Additionally, users may believe that SCADA networks are secure as the networks are physically secured and disconnected from the internet.

SCADA systems 850 are used to control and monitor physical processes including, for example, transmission of electricity, transportation of gas and oil in pipelines, water distribution, wind turbines and wind farms, traffic lights, etc. A secure SCADA system may ensure a low probability of system compromise or destruction resulting in smooth functioning of multiple areas of society. For example, a blackout caused by a compromised electrical SCADA system would cause financial losses to the customers that receive electricity from the SCADA based source.

In some examples, SCADA system 850 may face multiple threat vectors, for example, unauthorized access to the SCADA control software or packet access to network segments hosting SCADA devices. In some cases, unauthorized access may include human access or changes induced intentionally or accidentally by virus infections, software threats, etc., residing on a control host machine. Additionally, the control protocol may lack any form of cryptographic security which provides for an attacker to control a SCADA device by sending commands over a network. In some examples, SCADA users assume that a VPN provides sufficient protection and may not be aware that security can be bypassed with physical access to SCADA-related network jacks and switches. In some cases, industrial control vendors suggest approaching SCADA security (e.g., information security) with a defense in depth strategy that aids common IT practices.

The reliable functioning of SCADA systems 850 in societal infrastructure may be important to public health and safety. As such, attacks on SCADA systems 850 may directly or indirectly threaten public health and safety.

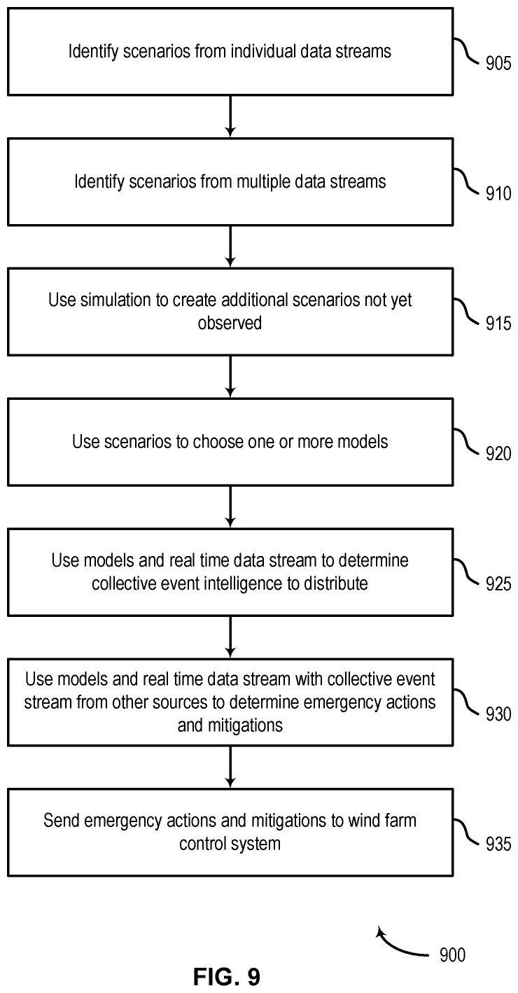

FIG. 9 shows an example of a method 900 for abnormal event detection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system identifies scenarios from individual data streams. In some cases, the operations of this step refer to, or may be performed by, abnormal event detection system as described with reference to FIG. 8.

At operation 910, the system identifies scenarios from multiple data streams. In some cases, the operations of this step refer to, or may be performed by, abnormal event detection system as described with reference to FIG. 8.

At operation 915, the system uses simulation to create additional scenarios not yet observed. In some cases, the operations of this step refer to, or may be performed by, abnormal event detection system as described with reference to FIG. 8. In some cases, the operations of this step refer to, or may be performed by, simulation module as described with reference to FIG. 7.

At operation 920, the system uses scenarios to choose one or more models. In some cases, the operations of this step refer to, or may be performed by, abnormal event detection system as described with reference to FIG. 8. In some cases, the operations of this step refer to, or may be performed by, modeling module as described with reference to FIG. 3.

At operation 925, the system uses models and real time data stream to determine collective event intelligence to distribute. In some cases, the operations of this step refer to, or may be performed by, abnormal event detection system as described with reference to FIG. 8. In some cases, the operations of this step refer to, or may be performed by, collective modeling and defense module as described with reference to FIG. 3.

At operation 930, the system uses models and real time data stream with collective event stream from other sources to determine emergency actions and mitigations. In some cases, the operations of this step refer to, or may be performed by, abnormal event detection system as described with reference to FIG. 8. In some cases, the operations of this step refer to, or may be performed by, scoring module as described with reference to FIG. 3.

At operation 935, the system sends emergencies actions and mitigations to wind farm control system. In some cases, the operations of this step refer to, or may be performed by, abnormal event detection system as described with reference to FIG. 8. In some cases, the operations of this step refer to, or may be performed by, real time mitigation module as described with reference to FIG. 3.

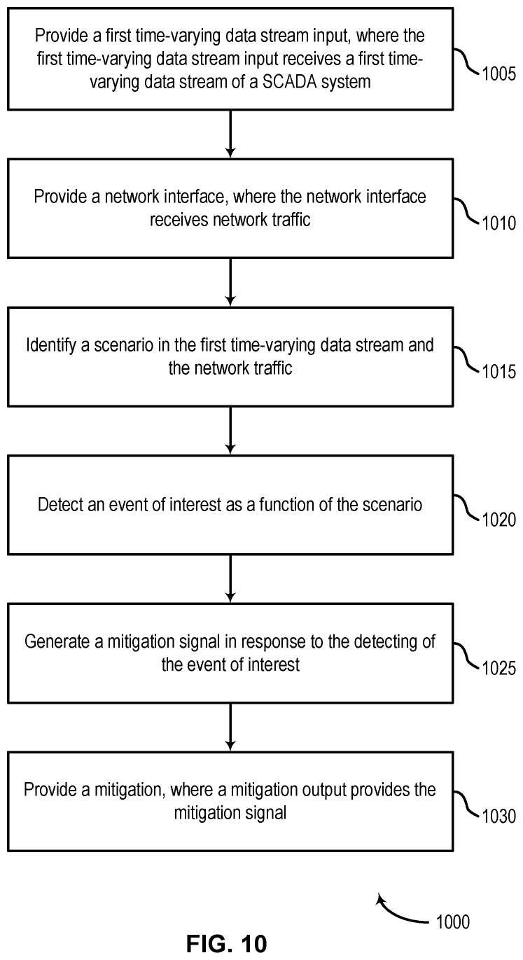

FIG. 10 shows an example of a method 1000 for abnormal event detection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system provides a first time-varying data stream input, where the first time-varying data stream input receives a first time-varying data stream of a SCADA system. In some cases, the operations of this step refer to, or may be performed by, abnormal event detection system as described with reference to FIG. 8.

At operation 1010, the system provides a network interface, where the network interface receives network traffic. In some cases, the operations of this step refer to, or may be performed by, abnormal event detection system as described with reference to FIG. 8.

At operation 1015, the system identifies a scenario in the first time-varying data stream and the network traffic. In some cases, the operations of this step refer to, or may be performed by, abnormal event detection system as described with reference to FIG. 8.

At operation 1020, the system detects an event of interest as a function of the scenario. In some cases, the operations of this step refer to, or may be performed by, abnormal event detection system as described with reference to FIG. 8.

At operation 1025, the system generates a mitigation signal in response to the detecting of the event of interest. In some cases, the operations of this step refer to, or may be performed by, abnormal event detection system as described with reference to FIG. 8.

At operation 1030, the system provides a mitigation, where a mitigation output provides the mitigation signal. In some cases, the operations of this step refer to, or may be performed by, abnormal event detection system as described with reference to FIG. 8.

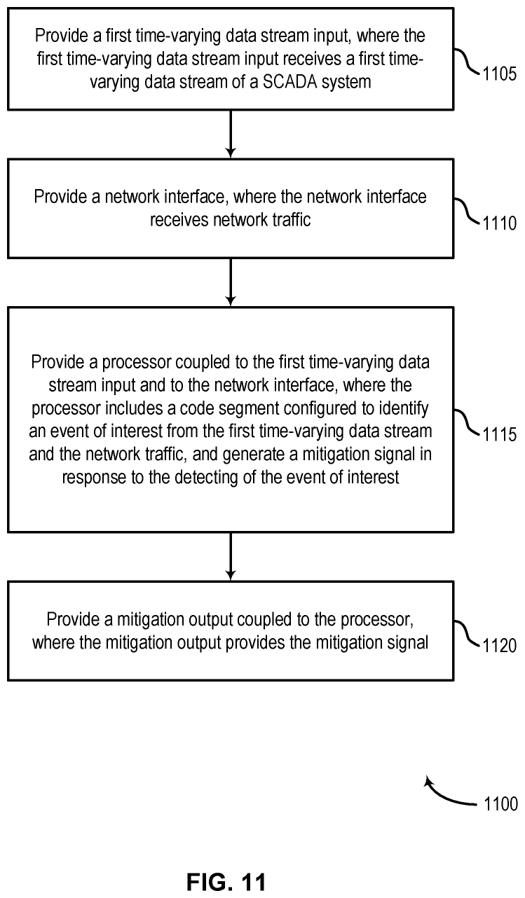

FIG. 11 shows an example of a method 1100 for abnormal event detection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system provides a first time-varying data stream input, where the first time-varying data stream input receives a first time-varying data stream of a SCADA system. In some cases, the operations of this step refer to, or may be performed by, first time-varying data stream input as described with reference to FIG. 8.

At operation 1110, the system provides a network interface, where the network interface receives network traffic. In some cases, the operations of this step refer to, or may be performed by, network interface as described with reference to FIG. 8.

At operation 1115, the system provides a processor coupled to the first time-varying data stream input and to the network interface, where the processor includes a code segment configured to identify an event of interest from the first time-varying data stream and the network traffic, and generate a mitigation signal in response to the detecting of the event of interest. In some cases, the operations of this step refer to, or may be performed by, processor as described with reference to FIG. 8.

At operation 1120, the system provides a mitigation output coupled to the processor, where the mitigation output provides the mitigation signal. In some cases, the operations of this step refer to, or may be performed by, mitigation output as described with reference to FIG. 8.

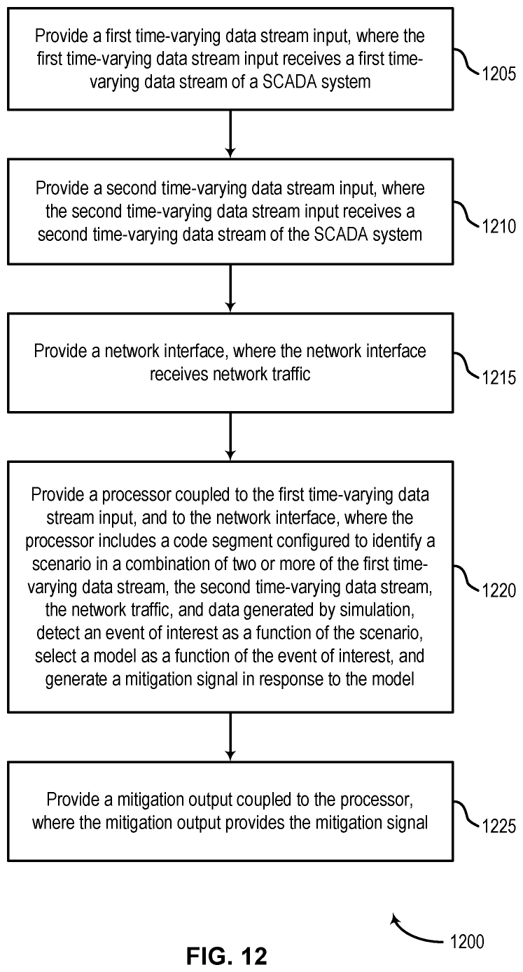

FIG. 12 shows an example of a method 1200 for abnormal event detection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system provides a first time-varying data stream input, where the first time-varying data stream input receives a first time-varying data stream of a SCADA system. In some cases, the operations of this step refer to, or may be performed by, first time-varying data stream input as described with reference to FIG. 8.

At operation 1210, the system provides a second time-varying data stream input, where the second time-varying data stream input receives a second time-varying data stream of the SCADA system. In some cases, the operations of this step refer to, or may be performed by, second time-varying data stream input as described with reference to FIG. 8.

At operation 1215, the system provides a network interface, where the network interface receives network traffic. In some cases, the operations of this step refer to, or may be performed by, network interface as described with reference to FIG. 8.

At operation 1220, the system provides a processor coupled to the first time-varying data stream input, and to the network interface, where the processor includes a code segment configured to identify a scenario in a combination of two or more of the first time-varying data stream, the second time-varying data stream, the network traffic, and data generated by simulation, detect an event of interest as a function of the scenario, select a model as a function of the event of interest, and generate a mitigation signal in response to the model. In some cases, the operations of this step refer to, or may be performed by, processor as described with reference to FIG. 8.

At operation 1225, the system provides a mitigation output coupled to the processor, where the mitigation output provides the mitigation signal. In some cases, the operations of this step refer to, or may be performed by, mitigation output as described with reference to FIG. 8.

Accordingly, the present disclosure includes the following aspects.

Apparatus for detection of abnormal wind farm events is described. One or more aspects of the apparatus include a first time-varying data stream input, wherein the first time-varying data stream input receives a first time-varying data stream of a SCADA system; a network interface, wherein the network interface receives network traffic; a processor coupled to the first time-varying data stream input and to the network interface, wherein the processor comprises a code segment configured to identify an event of interest from the first time-varying data stream and the network traffic, and generate a mitigation signal in response to the detecting of the event of interest; and a mitigation output coupled to the processor, wherein the mitigation output provides the mitigation signal.

A system for wind farms, comprising: a first time-varying data stream input, wherein the first time-varying data stream input receives a first time-varying data stream of a SCADA system; a network interface, wherein the network interface receives network traffic; a processor coupled to the first time-varying data stream input and to the network interface, wherein the processor comprises a code segment configured to identify an event of interest from the first time-varying data stream and the network traffic, and generate a mitigation signal in response to the detecting of the event of interest; and a mitigation output coupled to the processor, wherein the mitigation output provides the mitigation signal.

A method of manufacturing an apparatus for wind farms is described. The method includes a first time-varying data stream input, wherein the first time-varying data stream input receives a first time-varying data stream of a SCADA system; a network interface, wherein the network interface receives network traffic; a processor coupled to the first time-varying data stream input and to the network interface, wherein the processor comprises a code segment configured to identify an event of interest from the first time-varying data stream and the network traffic, and generate a mitigation signal in response to the detecting of the event of interest; and a mitigation output coupled to the processor, wherein the mitigation output provides the mitigation signal.

A method of using an apparatus for wind farms is described. The method includes a first time-varying data stream input, wherein the first time-varying data stream input receives a first time-varying data stream of a SCADA system; a network interface, wherein the network interface receives network traffic; a processor coupled to the first time-varying data stream input and to the network interface, wherein the processor comprises a code segment configured to identify an event of interest from the first time-varying data stream and the network traffic, and generate a mitigation signal in response to the detecting of the event of interest; and a mitigation output coupled to the processor, wherein the mitigation output provides the mitigation signal.

In some aspects, the event of interest is identified based on identifying a scenario in the first time-varying data stream and the network traffic, and detecting the event of interest as a function of the scenario.

Some examples of the apparatus, system, and method further include a second time-varying data stream input, wherein the second time-varying data stream input receives a second time-varying data stream of the supervisory control and data acquisition system.

In some aspects, the processor comprises the code segment configured to identify the scenario in the first time-varying data stream, the second time-varying data stream, and the network traffic, wherein the scenario is not apparent in the first time-varying data stream and the network traffic without the second time-varying data stream.

In some aspects, the SCADA system is coupled to a wind farm.

In some aspects, the processor is further coupled to an external data stream from a second wind farm and the code segment is further configured to identify at least one external event and detect the event of interest as a function of the scenario and the at least one external event.

In some aspects, the code segment is further configured to identify the scenario wherein the data is synthetic data generated by a digital twin.

In some aspects, the code segment is further configured to identify the scenario wherein the data is synthetic data generated by combining two or more time varying data streams.

In some aspects, the system is located at a first facility.

Some examples of the apparatus, system, and method further include a second processor located at a second facility, wherein the second facility is a remote facility. Some examples further include a second network interface at the second facility, wherein the second network interface is coupled to the second processor, and is coupled to the network interface via a computer network, wherein the mitigation output is coupled to the network interface and wherein the network interface transmits the mitigation signal to the second network interface via the computer network, and wherein the second processor comprises a second code segment configured to receive the mitigation signal from the mitigation output via the computer network.

In some aspects, the first facility is a first wind farm and the second facility is a second wind farm.

Method for detection of abnormal wind farm events is described. One or more aspects of the method include providing a first time-varying data stream input, wherein the first time-varying data stream input receives a first time-varying data stream of a SCADA system; providing a network interface, wherein the network interface receives network traffic; identifying a scenario in the first time-varying data stream and the network traffic; detecting an event of interest as a function of the scenario; generating a mitigation signal in response to the detecting of the event of interest; and providing a mitigation, wherein a mitigation output provides the mitigation signal.

An apparatus for wind farms is described. The apparatus includes a processor, memory in electronic communication with the processor, and instructions stored in the memory. The instructions are operable to cause the processor to perform the steps of providing a first time-varying data stream input, wherein the first time-varying data stream input receives a first time-varying data stream of a SCADA system; providing a network interface, wherein the network interface receives network traffic; identifying a scenario in the first time-varying data stream and the network traffic; detecting an event of interest as a function of the scenario; generating a mitigation signal in response to the detecting of the event of interest; and providing a mitigation, wherein a mitigation output provides the mitigation signal.

A non-transitory computer readable medium storing code for wind farms is described. In some examples, the code comprises instructions executable by a processor to perform the steps of: providing a first time-varying data stream input, wherein the first time-varying data stream input receives a first time-varying data stream of a SCADA system; providing a network interface, wherein the network interface receives network traffic; identifying a scenario in the first time-varying data stream and the network traffic; detecting an event of interest as a function of the scenario; generating a mitigation signal in response to the detecting of the event of interest; and providing a mitigation, wherein a mitigation output provides the mitigation signal.

System for detection of abnormal wind farm events is described. One or more aspects of the system include providing a first time-varying data stream input, wherein the first time-varying data stream input receives a first time-varying data stream of a SCADA system; providing a network interface, wherein the network interface receives network traffic; identifying a scenario in the first time-varying data stream and the network traffic; detecting an event of interest as a function of the scenario; generating a mitigation signal in response to the detecting of the event of interest; and providing a mitigation, wherein a mitigation output provides the mitigation signal.

Some examples of the method, apparatus, non-transitory computer readable medium, and system further include providing a second time-varying data stream input, wherein the second time-varying data stream input receives a second time-varying data stream of the SCADA system.

In some aspects, the scenario is identified in the first time-varying data stream, the second time-varying data stream, and the network traffic, wherein the scenario is not apparent in the first time-varying data stream and the network traffic without the second time-varying data stream.

In some aspects, the first time-varying data stream is provided by a wind farm.

Some examples of the method, apparatus, non-transitory computer readable medium, and system further include identifying at least one external event from a second wind farm. Some examples further include detecting the event of interest as a function of the scenario and the at least one external event.

In some aspects, the data is synthetic data generated by a digital twin.

In some aspects, the data is synthetic data generated by combining two or more time varying data streams.

In some aspects, the first time-varying data stream input is provided from a first facility.

Some examples of the method, apparatus, non-transitory computer readable medium, and system further include receiving, at a second facility, the mitigation signal from the mitigation output.

In some aspects, the first facility is a first wind farm and the second facility is a second wind farm.

Apparatus for detection of abnormal wind farm events is described. One or more aspects of the apparatus include a first time-varying data stream input, wherein the first time-varying data stream input receives a first time-varying data stream of a SCADA system; a second time-varying data stream input, wherein the second time-varying data stream input receives a second time-varying data stream of the SCADA system; a network interface, wherein the network interface receives network traffic; a processor coupled to the first time-varying data stream input, and to the network interface, wherein the processor comprises a code segment configured to identify a scenario in a combination of two more of the first time-varying data stream, the second time-varying data stream, the network traffic, and data generated by simulation, detect an event of interest as a function of the scenario, select a model as a function of the event of interest, and generate a mitigation signal in response to the model; and a mitigation output coupled to the processor, wherein the mitigation output provides the mitigation signal.

A system for wind farms, comprising: a first time-varying data stream input, wherein the first time-varying data stream input receives a first time-varying data stream of a SCADA system; a second time-varying data stream input, wherein the second time-varying data stream input receives a second time-varying data stream of the SCADA system; a network interface, wherein the network interface receives network traffic; a processor coupled to the first time-varying data stream input, and to the network interface, wherein the processor comprises a code segment configured to identify a scenario in a combination of two or more of the first time-varying data stream, the second time-varying data stream, the network traffic, and data generated by simulation, detect an event of interest as a function of the scenario, select a model as a function of the event of interest, and generate a mitigation signal in response to the model; and a mitigation output coupled to the processor, wherein the mitigation output provides the mitigation signal.

A method of manufacturing an apparatus for wind farms is described. The method includes a first time-varying data stream input, wherein the first time-varying data stream input receives a first time-varying data stream of a SCADA system; a second time-varying data stream input, wherein the second time-varying data stream input receives a second time-varying data stream of the SCADA system; a network interface, wherein the network interface receives network traffic; a processor coupled to the first time-varying data stream input, and to the network interface, wherein the processor comprises a code segment configured to identify a scenario in a combination of two or more of the first time-varying data stream, the second time-varying data stream, the network traffic, and data generated by simulation, detect an event of interest as a function of the scenario, select a model as a function of the event of interest, and generate a mitigation signal in response to the model; and a mitigation output coupled to the processor, wherein the mitigation output provides the mitigation signal.

A method of using an apparatus for wind farms is described. The method includes a first time-varying data stream input, wherein the first time-varying data stream input receives a first time-varying data stream of a SCADA system; a second time-varying data stream input, wherein the second time-varying data stream input receives a second time-varying data stream of the SCADA system; a network interface, wherein the network interface receives network traffic; a processor coupled to the first time-varying data stream input, and to the network interface, wherein the processor comprises a code segment configured to identify a scenario in a combination of two or more of the first time-varying data stream, the second time-varying data stream, the network traffic, and data generated by simulation, detect an event of interest as a function of the scenario, select a model as a function of the event of interest, and generate a mitigation signal in response to the model; and a mitigation output coupled to the processor, wherein the mitigation output provides the mitigation signal.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A system for detecting abnormal events comprising;
a first time-varying data stream input, wherein the first time-varying data stream input receives a first time-varying data stream of a SCADA system;
a network interface, wherein the network interface receives network traffic;
a processor coupled to the first time-varying data stream input, and to the network interface, wherein the processor comprises a code segment configured to:
identify an event of interest from the first time-varying data stream and the network traffic;
generate a mitigation signal in response to the detecting of the event of interest; and
a mitigation output coupled to the processor, wherein the mitigation output provides the mitigation signal.

2. The system of claim 1 wherein said system for detecting abnormal events further wherein the code segment within the processor coupled to the first time-varying data stream input, and to the network traffic is configured to:
identify said event of interest comprising:
identify a scenario in the first time-varying data stream and the network traffic; and
detect said event of interest as a function of the scenario.

3. The system of claim 2 wherein said system for detecting abnormal events further comprises:
a second time-varying data stream input, wherein the second time-varying data stream input receives a second time-varying data stream of said SCADA system; and
said processor, wherein the processor comprises said code segment configured to:
identify said scenario in the first time-varying data stream, the second time-varying data stream and the network traffic, wherein said scenario is not apparent in said first time-varying data stream and said network traffic without said second time-varying data stream.

4. The system of claim 2 wherein said SCADA system is coupled to a wind farm.

5. The system of claim 2 wherein said processor is further coupled to an external data stream from a second wind farm, and wherein said code segment is configured to:
identify at least one external event;
detect said event of interest as a function of said scenario and the at least one external event.

6. The system of claim 2 wherein said code segment is further configured to identify said scenario wherein the data is synthetic data generated by a digital twin.

7. The system of claim 2 wherein said code segment is further configured to identify said scenario wherein the data is synthetic data generated by combining two or more time varying data streams.

8. The system of claim 1 wherein said system is located at a first facility, wherein the system further comprises:
another processor located at a second facility, wherein the second facility is a remote facility;
another network interface at the second facility, wherein the other network interface is coupled to the other processor, and is coupled to the network interface via a computer network, wherein the mitigation output is coupled to the network interface and wherein the network interface transmits the mitigation signal to the other network interface via the computer network, and wherein the other processor comprises another code segment configured to receive the mitigation signal from the mitigation output via the computer network.

9. The system of claim 8 wherein said first facility is a first wind farm, and wherein said second facility is a second wind farm.

10. A method for detecting abnormal events comprising;
providing a first time-varying data stream input, wherein the first time-varying data stream input receives a first time-varying data stream of a SCADA system;
providing a network interface, wherein the network interface receives network traffic;
identifying a scenario in the first time-varying data stream and the network traffic;
detecting an event of interest as a function of the scenario; and
generating a mitigation signal in response to the detecting of the event of interest; and
providing a mitigation, wherein a mitigation output provides the mitigation signal.

11. The method of claim 10 further comprising:
providing a second time-varying data stream input, wherein the second time-varying data stream input receives a second time-varying data stream of said SCADA system; and
said identifying comprises identifying said scenario in the first time-varying data stream, the second time-varying data stream and the network traffic, wherein said scenario is not apparent in said first time-varying data stream and said network traffic without said second time-varying data stream.

12. The method of claim 11 wherein said first time-varying data stream is provided by a wind farm.

13. The method of claim 12 further comprising:
identifying at least one external event from a second wind farm; and
detecting said event of interest as a function of said scenario and the at least one external event.

14. The method of claim 10 further comprising said identifying said scenario wherein the data is synthetic data generated by a digital twin.

15. The method of claim 10 further comprising said identifying said scenario wherein the data is synthetic data generated by combining two or more time varying data streams.

16. The method of claim 10 wherein said providing said first time-varying data stream input from a first facility, further comprising:
receiving at a second facility the mitigation signal from the mitigation output.

17. The method of claim 16 wherein said providing said first time-varying data stream input from said first facility, wherein said first facility is a first wind farm, and said receiving at said second facility the mitigation signal, wherein said second facility is a second wind farm.

18. A system for detecting abnormal events comprising;
a first time-varying data stream input, wherein the first time-varying data stream input receives a first time-varying data stream of a SCADA system;
a second time-varying data stream input, wherein the second time-varying data stream input receives a second time-varying data stream of the SCADA system;
a network interface, wherein the network interface receives network traffic;
a processor coupled to the first time-varying data stream input, and to the network interface, wherein the processor comprises a code segment configured to:
identify a scenario in a combination of two or more of the first time-varying data stream, the second time-varying data stream, the network traffic, and data generated by simulation;
detect an event of interest as a function of the scenario; and
select a model as a function of the event of interest;
generate a mitigation signal in response to the model; and
a mitigation output coupled to the processor, wherein the mitigation output provides the mitigation signal.
